(19) United States
(12) Patent Application Publication
(10) Pub. No.: US 2010/0302176 A1
(43) Pub. Date: Dec. 2, 2010

(54) ZOOM-IN FUNCTIONALITY

(75) Inventors: Jarmo Antero Nikula, Jaali (FI); Mika Allan Salmela, Oulu (FI); Jyrki Veikko Leskela, Haukipudas (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/474,407

(22) Filed: May 29, 2009

(51) Int. Cl. G06F 3/041

(52) U.S. Cl. 345/173; 715/863

(57) ABSTRACT

A user interface includes a controller which is configured to display image data, receive input indicating a touch area corresponding to at least a portion of the image data, perform a zoom-in action on the at least portion of the image data and to display at least a portion of the zoomed-in portion in addition to the remainder of the image data in response thereto.

### BACKGROUND

1. Field

The present application relates to a user interface, an apparatus and a method for control of displaying image data, and in particular to a user interface, an apparatus and a method for improved zooming of displayed image data.

2. Brief Description of Related Developments

More and more electronic devices such as mobile phones, Media players, Personal Digital Assistants (PDAs) and computers both laptops and desktops are being used to display various image data such as media files (such as video files, slide shows and artwork for music files), internet content, image data representing maps, documents or other files and other image data.

A common problem is that the image (possibly representing a document or other file) is larger than the available display area (either the display size or an associated window's size). The common solution is to provide a stepwise zoom in function which allows a user to zoom in on the displayed content.

An apparatus that allows an easy to use and learn zoom in function would thus be useful in modern day society

### SUMMARY

On this background, it would be advantageously to provide a user interface, an apparatus and a method that overcomes or at least reduces the drawbacks indicated above by providing an apparatus according to the claims.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIGS. 2a and b are views of each an apparatus according to an embodiment,

FIG. 3 is a block diagram illustrating the general architecture of an apparatus of FIG. 2a in accordance with the present application,

FIG. 4a to e are screen shot views of an apparatus or views of an application window according to an embodiment,

FIGS. 5a-5c are application views of an apparatus or views of an application window according to an embodiment, and

FIG. 6 is a flow chart describing a method according to an embodiment of the application.

### DETAILED DESCRIPTION OF THE DISCLOSED EMBODIMENTS

In the following detailed description, the user interface, the apparatus, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

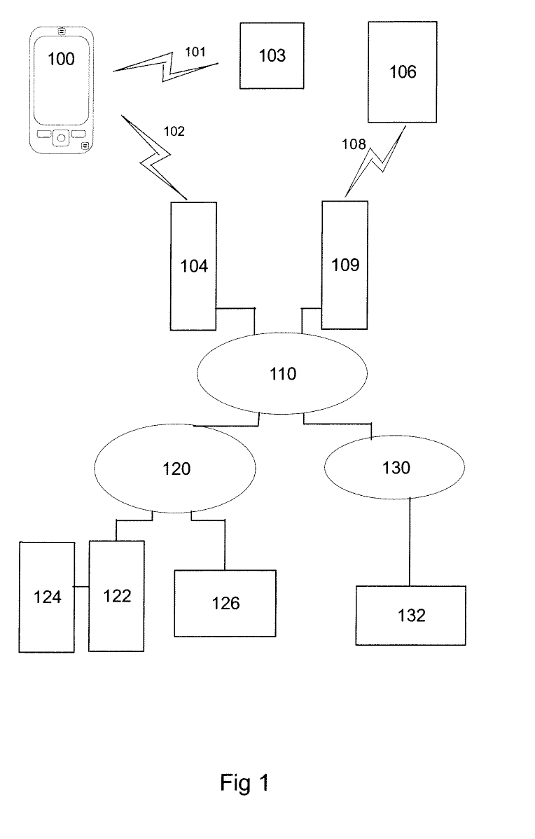

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency (RF) links 102, 108 via base stations 104, 109. The mobile telecommunications network 110 may be in compliance with any commercially available mobile telecommunications standard, such as Group Spéciale Mobile (GSM), Universal Mobile Telecommunications System (UMTS), Digital Advanced Mobile Phone system (D-AMPS), The code division multiple access standards (CDMA and CDMA2000), Freedom Of Mobile Access (FOMA), and Time Division-Synchronous Code Division Multiple Access (TD-SCDMA).

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 as is commonly known by a skilled person. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

A computer such as a laptop or desktop can also be connected to the network both via a radio link such as a WiFi link, which is the popular term for a radio frequency connection using the WLAN (Wireless Local Area Network) standard IEEE 802.11.

It should be noted that the teachings of this application are also capable of being utilized in an internet network of which the telecommunications network described above may be a part of.

It should be noted that even though the teachings herein are described solely to wireless networks it is in no respect to be limited to wireless networks as such, but it to be understood to be usable in the Internet or similar networks.

It should thus be understood that an apparatus according to the teachings herein may be a mobile communications terminal, such as a mobile telephone, a media player, a music player, a video player, an electronic book, a personal digital assistant, a laptop as well as a stationary device such as a desktop computer or a server.

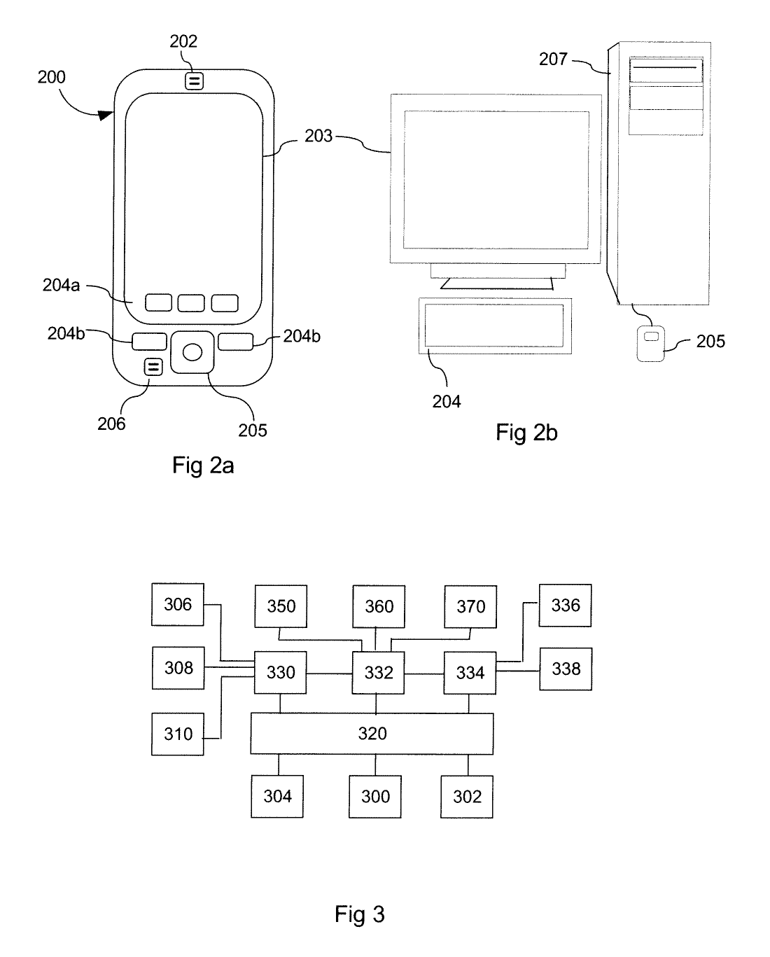

An embodiment 200 of the mobile terminal 100 is illustrated in more detail in FIG. 2a. The mobile terminal 200 comprises a speaker or earphone 202, a microphone 206, a main or first display 203 and a set of keys 204 which may include keys such as soft keys 204b, 204c and a joystick 205 or other type of navigational input device. In this embodiment the display 203 is a touch-sensitive display also called a touch display which displays various virtual keys 204a.

An alternative embodiment of the teachings herein is illustrated in FIG. 2b in the form of a computer which in this example is a desktop computer 200. The computer has a screen 203, a keypad 204 and navigational means in the form of a cursor controlling input means which in this example is a computer mouse 205.

It should be noted that a computer can also be connected to a wireless network as shown in FIG. 1 where the computer 200 would be an embodiment of the device 100.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM), Read Only Memory (ROM), Electrically Erasable Programmable Read-Only Memory (EEPROM), flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a media file player 350, a notepad application 360, as well as various other applications 370, such as applications for voice calling, video calling, sending and receiving messages such as Short Message Service (SMS), Multimedia Message Service (MMS) or email, web browsing, an instant messaging application, a phone book application, a calendar application, a control panel application, a camera application, one or more video games, etc. It should be noted that two or more of the applications listed above may be executed as the same application.

The MMI 334 also includes one or more hardware controllers, which together with the MMI drivers cooperate with the first display 336/203, and the keypad 338/204 as well as various other Input/Output devices such as microphone, speaker, vibrator, ringtone generator, LED indicator, etc.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

In the following description it will be assumed that the display is a touch display and that a tap is performed with a stylus or finger or other touching means tapping on a position on the display. It should be noted that a tap may also be included by use of other pointing means such as a mouse or touch pad controlled cursor which is positioned at a specific position and then a clicking action is performed. This analogy is commonly known in the field and will be clear to a skilled person. In the description it will be assumed that a tap input comprises a clicking action at an indicated position.

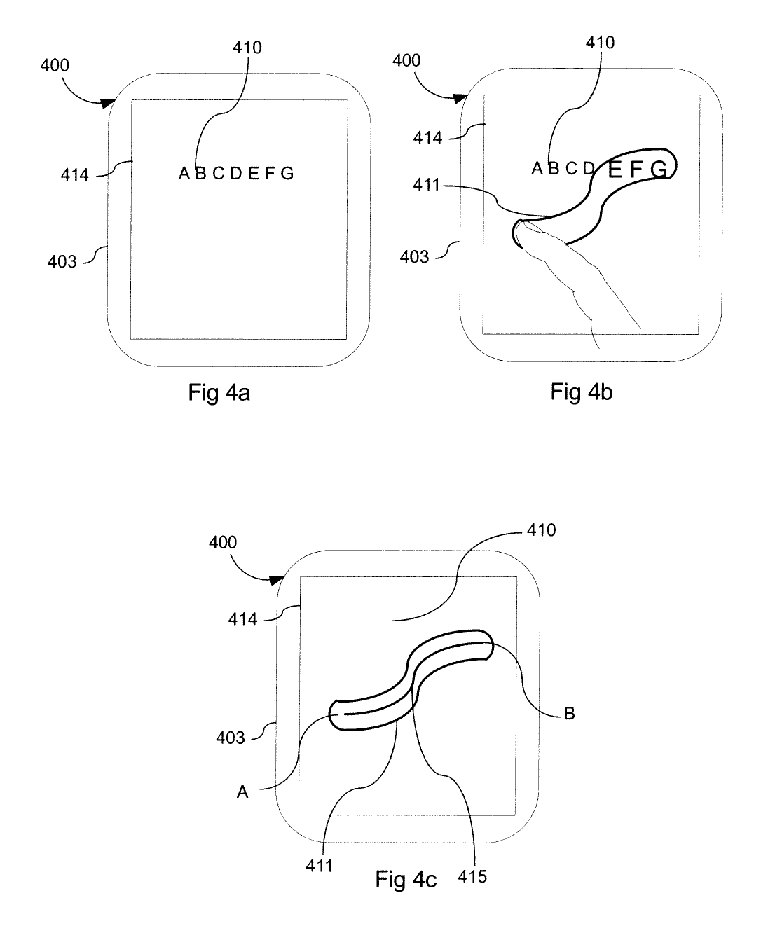

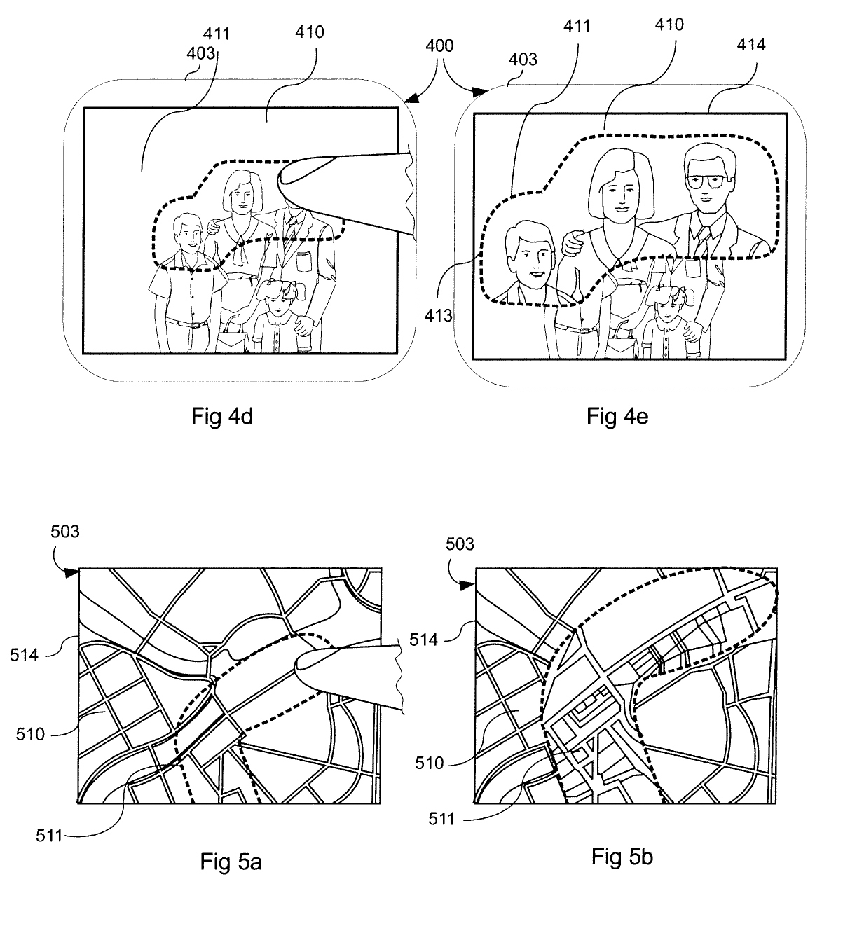

FIG. 4 show a series of screen shot views of an apparatus 400 according to the teachings herein. It should be noted that such an apparatus is not limited to a mobile phone, but can be any apparatus capable of displaying image data.

It should be noted that the image data may be stored on said apparatus or remotely at another position or in another apparatus. Image data may also be downloaded while it is being displayed, so called streaming.

Examples of such apparatuses are computers, media players, mobile phones, personal digital assistants (PDA), digital cameras, navigation devices such as GPS (Global Positioning System) devices, game consoles electronic books, Digital Video Disc players, television sets, photo and video cameras, electronic books and electronic dictionaries.

The apparatus 400 has a display 403, which in this embodiment is a touch display.

A controller is configured to display image data or content 410, see FIG. 4a. This image data may represent an image, a video, a document, a map, downloaded internet content, other downloaded content etc. The different alternatives to what image data may be displayed on an electronic device are well-known. In one embodiment the image data 410 is displayed in an application window 414.

By realizing that there is a problem in that if a user zooms in the whole content he will loose overview of the image data and has to pan or scroll the content to maintain the overview. However, by only zooming in on a portion of the displayed image data a user will be able to maintain an overview of the complete content while still being able to see a specific area more clearly.

A controller is configured to receive input indicating an area 411 on the display 403. In one embodiment the area 411 is encompassed within the application window 414, see FIG. 4b.

The controller is configured to perform a zoom-in action on the area 411, hereafter referred to as the touch area 411 and to display the touch area at a different magnification, that is, to display it as zoomed in.

In one embodiment the controller is configured to determine the touch area 411 to also include an area surrounding the immediate touch area 411. Hereafter this will be referred to as the touch area 411. In such an embodiment the zoomed-in area is larger than the area actually touched which enables a user to zoom-in larger areas which is useful when using a stylus or for users with small fingers.

In one embodiment the magnification is one of the factors: 1:1.25, 1:1.30, 1:1.35, 1:1.40, 1:1.45, 1:1.50, 1:1.55, 1:1.60, 1:1.65, 1:1.70, 1:1.75, 1:1.80, 1:1.85, 1:1.90, 1:1.95, 1:2, 1:2.25, 1:2.50, 1:2.75, 1:3, 1:4, 1:5, 1:10. It should be noted that other magnification factors are also possible such as any factor in between the factors listed.

In one embodiment the magnification factor is not constant. In one such embodiment the magnification factor is dependant on the size of the touch area 411 and in one embodiment on the size of the touch area 411 in relation to the size of the application window and in one embodiment on the size of the touch area 411 in relation to the size of the displayed content 410.

In one embodiment the controller is configured to determine for each pixel to be displayed close to the touching area 411 in a manner resembling what is known as a worm-like or free-form lens effect. This is based upon determining whether a distance from a pixel to the nearest point on the center line 415 is below a first threshold value and if so magnify the image data corresponding to that pixel. If the distance is larger than the first threshold value it is determined if it is below a second threshold value and if so the image data corresponding to that pixel belongs to the transition area 413 and then magnify it accordingly. Otherwise the image data corresponding to that pixel is not magnified. In one embodiment this is done by tracing the center of the touching area 411 and performing the determination for the adjacent pixels.

Mathematically this may be expressed as a generalization of the radial coordinate remapping. The equation below maps the original image f(x,y) into a modified image g(x,y) as a piecewise continuous function where (see FIG. 4c):
(xi,yi), iε a.b is a path drawn on the display, i.e. representing the centerline 415 of the touch area 411 from point A to point B (see figure 4c); R0 and R1 are the distances of outer and inner boundaries of a lens frame seen from the center line 415;
(xc, yc) is the center point of the free-form lens; and
M is the magnification factor inside the inner boundaries of the lens.

$$\begin{matrix}g ( x , y ) = \\ \{ \begin{matrix}f ( x , y ) , {r}_{min} > {R}_{o} \\ f ( {x}_{c} + ( x - {x}_{c} ) [ 1 \frac{\begin{matrix}( {R}_{o} - {r}_{min} ) \\ ( 1 - \frac{1}{M} )\end{matrix}}{{R}_{o} - {R}_{i}} ] , {y}_{c} + ( y - {y}_{c} ) [ 1 \frac{\begin{matrix}( {R}_{o} - {r}_{min} ) \\ ( 1 - \frac{1}{M} )\end{matrix}}{{R}_{o} - {R}_{i}} ] , {R}_{i} > {r}_{min} > {R}_{o} \\ f ( {x}_{c} + \frac{( x - {x}_{c} )}{M} , {y}_{c} + \frac{( y - {y}_{c} )}{M} ) , {r}_{min} < {R}_{i}\end{matrix} & \\ {r}_{min} = min ( \sqrt{\begin{matrix}{[ x - ( \frac{1}{M} ( {x}_{i} - {x}_{c} ) + {x}_{c} ) ]}^{2} + \\ {[ y - ( \frac{1}{M} ( {y}_{i} - {y}_{c} ) + {y}_{c} ) ]}^{2}\end{matrix}} ) , & \\ i ∈ a … b & \\ {x}_{c} = \frac{{\sum }_{i = a}^{b} {x}_{i}}{b - a + 1} , {y}_{c} = \frac{{\sum }_{i = a}^{b} {y}_{i}}{b - a + 1} & \end{matrix}$$

In one embodiment a controller is configured to continue the zoom-in action until a zoom factor has been reached. The controller is thus configured to zoom in to a specified zoom-in factor or magnification.

In one embodiment a controller is configured to continue the zoom-in action until an area corresponding to a percentage of the touch area 411 has been zoomed in.

In one embodiment the magnification factor is not constant over the zoomed in area (411). In one such embodiment the magnification factor is dependant on the distance from the zoomed in pixel to the center line 415. In one embodiment the magnification factor varies linearly. In one embodiment the magnification factor varies non-linearly.

In one embodiment the controller is configured to first zoom in the touch area 411 at a first magnification and then to continue zooming in until a second magnification is reached.

In one embodiment the controller is configured to first zoom in the touch area 411 at a first size and then to continue zooming in until a second size is reached.

In one embodiment the controller is configured to first zoom in the touch area 411 at a first magnification and size and then to continue zooming in until a second magnification and size is reached.

In one embodiment the first magnification is 1:1.25.

In one embodiment the second magnification is 1:1.7.

It should be noted that any magnification from the listed ones may be used as a first or second magnification.

In one embodiment the first size is 108% of the touch area 411.

In one embodiment the second size is 115% of the touch area 411.

It should be noted that any size corresponding to a magnification from the listed magnifications may be used as a first or second size.

In one embodiment a controller is configured to continue the zoom-in action until a timeout value has been reached. The controller is thus configured to zoom in for a preset time.

In one embodiment a controller is configured to continue the zoom-in action until the first input is released. A user can thus control the zoom-in action by keeping his finger or stylus pressed against the display.

In one embodiment a controller is configured to continue the zoom-in action until an input indicating a position being remote from the zoomed-in area is received.

In one embodiment a controller is configured to stop the zoom-in action in response to receiving an input indicating a position being remote from the zoomed-in area.

In one embodiment a controller is configured to stop the zoom-in action when the zoomed-in area 411+413, fills the available display space.

In one such embodiment the zoom-in is continued until one edge of the zoomed-in area is adjacent an edge of the available display space. In one such embodiment the zoom-in is continued until two edges of the zoomed-in area are adjacent two edges of the available display space. In one such embodiment the zoom-in is continued until two edges of the zoomed-in area are adjacent two opposite edges of the available display space.

In one such embodiment the zoom-in is continued until three edges of the zoomed-in area are adjacent three edges of the available display space.

In one such embodiment the zoom-in is continued until four edges of the zoomed-in area are adjacent four edges of the available display space.

In one embodiment a controller is configured to cancel the zoom-in action in response to receiving an input indicating a position being remote from the zoomed-in area and thereby display the original image data 410.

In one embodiment the controller is configured to receive an input representing a further touch area (not shown) and in response thereto zoom-in on the further touch area.

In one such embodiment the further touch area partially overlaps the first touch area 411 wherein the zoomed in area is expanded to include the further touch area.

In one such embodiment the further touch area is encompassed within the first touch area 411 whereupon the further touch area is further zoomed in.

In one such embodiment the further touch area is encompassed within the first touch area 411 whereupon the first touch area is further zoomed in.

In one embodiment the controller is configured to display the zoomed-in touch area 411 so that the center of the zoomed-in area (411+413) corresponds to the center of the touch area 411.

In one embodiment the controller is configured to display the zoomed-in touch area 411 so that the center of the zoomed-in area (411+413) does not correspond to the center of the touch area 411. This enables a zoomed-in area (411+413) close to an edge of the application window 414 to be displayed in full.

In one embodiment the controller is configured to receive an input representing a panning action and in response thereto display the image data as being translated or panned.

In one such embodiment the input representing a panning action is a touch input comprising a gesture starting at a position inside the touch area 411.

FIGS. 4d and 4e are screenshot views of an apparatus as above where an image 410 is displayed. In FIG. 4d a user is making a stroke on the display 403 and a controller is configured to zoom in on the touched area 411 in response thereto. FIG. 4e shows the result.

In one embodiment the controller is configured to also perform a zoom-in action on an area 413 surrounding the touch area 411, hereafter referred to as a transitional area 413, see FIG. 4e where an image has been (partially) zoomed in. In one embodiment the controller is configured to display the content of or image data corresponding to the transition area 413 with a varying magnification. The magnification in the transition area 413 varies between zero magnification and the magnification used for the touch area 411. This will provide for a smooth transition from the zoomed-in content in the touch area 411 and the displayed image data 410.

As can be seen the zoomed-in area (411+413) is smoothly embedded in the image data 410 without sharp edges. This provides a user with an increased overview of how the zoomed-in area 411+413 is associated with the rest of the image data 410.

In one embodiment the controller is configured to display the zoom-in action as an animation. In one such embodiment the animation is performed in real time.

In one embodiment the controller is configured to stop displaying the zoomed-in area as being zoomed in after a time-out period has lapsed.

In one embodiment the controller is configured to continue displaying the zoomed-in area as being zoomed in until a cancellation input has been received.

In one such embodiment a user may zoom in on the subtitles of a video stream or file and the subtitles will be maintained as zoomed-in during the playback of the video file or stream.

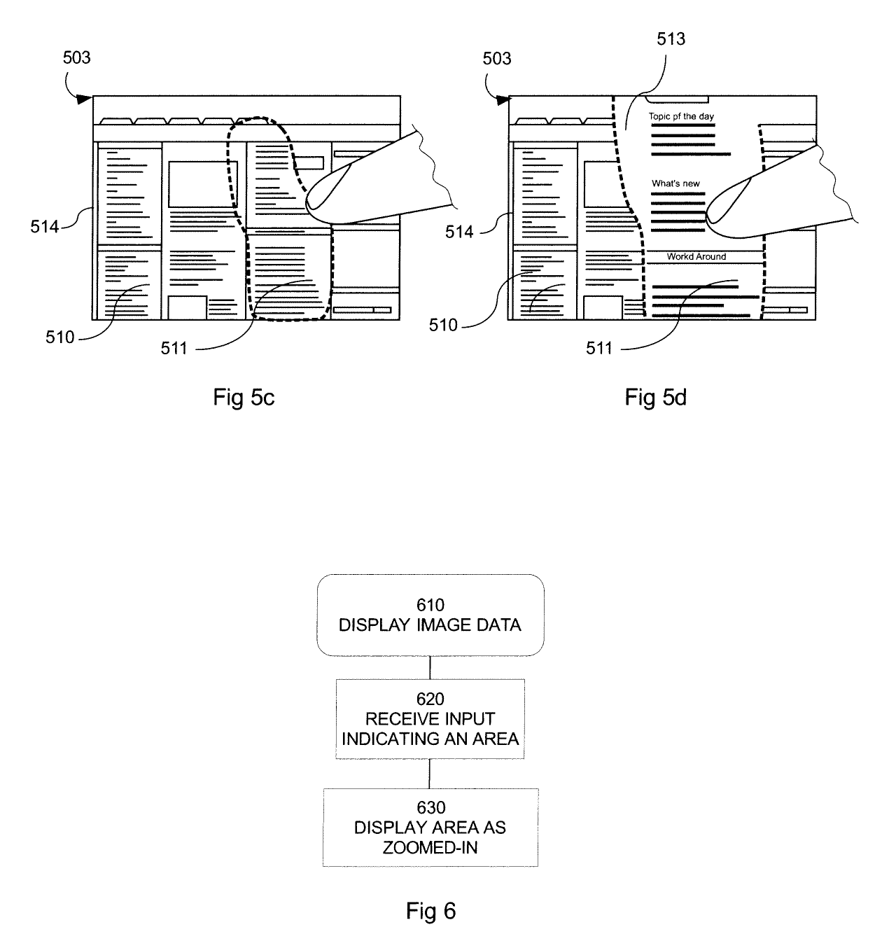

FIG. 5 shows a series of screen shot views of an apparatus (not shown) according to the teachings herein. It should be noted that such an apparatus is not limited to a mobile phone, but can be any apparatus capable of displaying image data.

It should be noted that the image data may be stored on said apparatus or remotely at another position or in another apparatus. Image data may also be downloaded while it is being displayed, so called streaming.

Examples of such apparatuses are computers, media players, mobile phones, personal digital assistants (PDA), digital cameras, navigation devices such as GPS (Global Positioning System) devices, game consoles electronic books, Digital Video Disc players, television sets, photo and video cameras, electronic books and electronic dictionaries.

The apparatus has a display 503, which in this embodiment is a touch display.

FIGS. 5a and b show an application window 514 in which a map or image data representing a map 510 is displayed. A user is stroking over the display 503 thereby marking and inputting a touch area 511. In FIGS. 5a and b the touch area 511 is differently illuminated than the surroundings. In this example this is for illustrating purposes and need not be implemented in an embodiment of the teachings herein.

In one embodiment the surrounding is displayed with a modified or altered illumination and the zoomed-in portion is displayed with the original illumination.

In one embodiment the zoomed-in portion is displayed with a modified or altered illumination and the surrounding is displayed with the original illumination.

In one embodiment the modified or altered illumination is made brighter than the original illumination.

In one embodiment the modified or altered illumination is made darker than the original illumination.

In one embodiment the surrounding is displayed as being blurred.

By changing the illumination or by providing another visual effect as given in the examples above a user is provided with an indication that the finger or stylus stroke has been registered. A user is also provided with an indication of which parts of the displayed content have already been marked.

In one embodiment a controller is configured to display a visual effect as given in the examples above gradually over the displayed content. In one such embodiment the visual effect is applied gradually to the transition area 513.

A controller is configured to perform a zoom-in action or operation in response to receiving the input indicating the touch area 511.

In one embodiment the controller is configured to display the zoomed-in touch area as enlarged to fill the display area 503 or application window 514.

In FIG. 5b the resulting displayed map is shown.

FIGS. 5c and d show an application window 514 in which a image data representing a downloaded web content 510 is displayed. A user is stroking over the display 503 thereby marking and inputting a touch area 511. In FIGS. 5c and d the touch area 511 is differently illuminated than the surroundings. In this example this is for illustrating purposes and need not be implemented in an embodiment of the teachings herein.

A controller is configured to perform a zoom-in action or operation in response to receiving the input indicating the touch area 511.

In this example the marked touch area 511 corresponds to an area which will be larger than the available window space and the controller is configured to display a portion of the zoomed-in touch area 511.

In one embodiment the controller is configured to receive an input representing a stroke gesture having a direction and originating within the touch area 511 and to display the image data 510 and the zoomed-in touch area 511 as translated in the direction given by the input. A user can thus pan the displayed data by stroking on the display.

In one embodiment the controller is configured to receive an input representing a stroke gesture having a direction and originating within the touch area 511 and to display the zoomed-in touch area 511 as translated in the direction given by the input. A user can thus pan the zoomed-in content by stroking on the display.

In FIG. 5d the resulting displayed content 510 is shown.

In one embodiment a controller is configured to determine and display a transition area 513 as has previously been described. In one such embodiment the controller is further configured to re-determine said transition area as the touch area 511 is translated or panned or scrolled.

FIG. 6 shows a flowchart describing a general method as has been discussed above. In a first step 610 image data is displayed. In a second step 620 an input is received indicating a touch area and a controller zooms in on the touch area in response thereto in step 630.

It should be noted that in one embodiment according to all the embodiments above the controller is configured to perform a zoom-out action instead of the zoom-in action having been described.

This allows a user to perceive an overview of a certain area of a displayed image. This is useful for map applications where a user may want to know how an area is connected to other areas without loosing the scale of another area being watched. For example if a user is traveling along a road and views this road and its surroundings in a navigation device, the user may want to obtain a view of what lies further ahead. The user may then touch over an area in front of the current position and the controller then displays a zoomed out version of that area in response thereto enabling a user to both see his current position and the surroundings at a first scale and the coming or traveled to surroundings at a different scale.

In one embodiment the controller is configured to receive a first type input and to perform a zoom-in action in response thereto and to receive a second type input and to perform a zoom-out action in response thereto. Examples of such second type inputs are multi-touch input, long press prior to moving, double tap prior to moving and a touch with a differently sized stylus.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, media players, personal organizers, computers or any other device designed for displaying image data.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user will be able to maintain an overview of the displayed image data or content while still being able to accurately see the most interesting data.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone and a desktop computer, it should be appreciated that the teachings of the present application may also be applied to other types of electronic devices, such as media players, video players, photo and video cameras, palmtop, laptop and desktop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. An apparatus comprising a controller, wherein said controller is arranged to:
display image data;
receive input indicating a touch area corresponding to at least a portion of said image data;
perform a zoom-in action on the at least portion of said image data; and to
display at least a portion of the zoomed-in portion in addition to the remainder of the image data in response thereto.

2. An apparatus according to claim 1, wherein said controller is configured to determine said touch area to also comprise a surrounding area.

3. An apparatus according to claim 1, wherein the controller is configured to determine a transition area and to perform a gradual zoom-in action on said transition area and to also display said transition area, wherein the gradual zoom-in action applies a varying magnification factor.

4. An apparatus according to claim 1, wherein said controller is configured to display said zoom-in action as an animation.

5. An apparatus according to claim 1, wherein the controller is configured to receive an input indicating a position falling inside the touch area and a direction and in response thereto display the zoomed-in portion of the image data as translated in the direction as indicated by the input.

6. An apparatus according to claim 1, wherein said controller is configured to receive said input through a touch display.

7. (canceled)

8. A user interface comprising a controller configured to:
display image data;
receive input indicating a touch area corresponding to at least a portion of said image data;
perform a zoom-in action on the at least portion of said image data; and to
display at least a portion of the zoomed-in portion in addition to the remainder of the image data in response thereto.

9. A computer readable medium comprising at least computer program code for controlling an apparatus, said computer readable medium comprising:
software code for displaying image data;
software code for receiving input indicating a touch area corresponding to at least a portion of said image data;
software code for performing a zoom-in action on the at least portion of said image data; and
software code for displaying at least a portion of the zoomed-in portion in addition to the remainder of the image data in response thereto.

10. A method for use in an apparatus comprising at least a processor, said method comprising:
displaying image data;
receiving input indicating a touch area corresponding to at least a portion of said image data;
performing a zoom-in action on the at least portion of said image data; and
displaying at least a portion of the zoomed-in portion in addition to the remainder of the image data in response thereto.

11. A method according to claim 10, further comprising determining said touch area to also comprise a surrounding area.

12. A method according to claim 10, further comprising determining a transition area and performing a gradual zoom-in action on said transition area and also displaying said transition area, wherein the gradual zoom-in action applies a varying magnification factor.

13. A method according to claim 10, further comprising displaying said zoom-in action as an animation.

14. A method according to claim 10, further comprising receiving an input indicating a position falling inside the touch area and a direction and in response thereto display the zoomed-in portion of the image data as translated in the direction as indicated by the input.

15. (canceled)

16. An apparatus according to claim 1, wherein said touch area comprises a path drawn on a display.

17. An apparatus according to claim 1, wherein said controller is configured to provide an indication that the touch area has been registered.

18. An apparatus according to claim 3, wherein the zoomed-in portion is smoothly embedded in the image data without sharp edges.

19. An apparatus according to claim 4, wherein said animation is performed in real-time.

20. A method according to claim 10, wherein said touch area comprises a path drawn on a display.

21. A method according to claim 10, further comprising providing an indication that the touch area has been registered.

22. A method according to claim 12, wherein the zoomed-in portion is smoothly embedded in the image data without sharp edges.
